(19) United States
(12) Patent Application Publication
(10) Pub. No.: US 2010/0220356 A1
(43) Pub. Date: Sep. 2, 2010

(54) IMAGE PROCESSING APPARATUS AND IMAGE PROCESSING METHOD

(75) Inventors: Yusuke Hamada, Kanagawa-ken (JP); Kazuhiro Ogura, Kanagawa-ken (JP); Mahina Nakamura, Tokyo (JP); Maki Sato, Kanagawa-ken (JP); Tsunehiro Motegi, Tokyo (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/707,977

(22) Filed: Feb. 18, 2010

Related U.S. Application Data
(60) Provisional application No. 61/155,972, filed on Feb. 27, 2009.

(30) Foreign Application Priority Data
Dec. 15, 2009 (JP) 2009283603

(51) Int. Cl. G06F 15/00

(52) U.S. Cl. 358/1.15

(57) ABSTRACT

According to one embodiment, an image processing apparatus includes a receiving portion to receive an image data composed of a plurality of pages and a print data including an information indicating a size of characters included in the image data, a decision portion, in case of generating an Nin1 image so as to reduce and print in a page images of different N (N is a positive integer) pages out of the plurality of pages of the print data received in the receiving portion, to decide a value of N within a range where the size of the characters of the Nin1 image is more than a prescribed value based on the information indicating the size of the characters, and a generating portion to generate the Nin1 image according to the value of N decided in the decision portion.

### CROSS-REFERENCE TO RELATED APPLICATION

This application is based upon and claims the benefit of priority from U.S. provisional application 61/155,972, filed on Feb. 27, 2009, the entire contents of all of which are incorporated herein by reference.

This application is also based upon and claims the benefit of priority from Japanese Patent Application No. 2009-283603, filed on Dec. 15, 2009, the entire contents of all of which are incorporated herein by reference.

### TECHNICAL FIELD

The present invention relates to an image processing apparatus and an image processing method.

### BACKGROUND

Conventionally, there is an image forming apparatus which performs, so-called, an Nin1 printing to print a document composed of N (N is a positive integer) pages in a sheet. By performing the Nin1 printing, the number of sheets to be used can be reduced, compared with a case where a page of the document is printed a one sheet

In such the image forming apparatus, if a user does an improper Nin1 setting, the printing is performed in the improper print setting. A setting in case that the characters become too small to read when the Nin1 printing is performed, for example, corresponds to the improper print setting.

As an example to avoid that such an improper Nin1 printing is performed, JP-A 2005-67131 is disclosed. In JP-A 2005-67131, whether or not a user does an improper Nin1 print setting is judged based on a size of the characters of the document and a size of the print sheets. And in case that a user does an improper Nin1 print setting is judged, the apparatus warns the user to prevent previously that the improper Nin1 printing is performed.

In JP-A 2005-67131, an improper Nin1 printing can be prevented, but it is an user that sets the Nin1 print finally. For the reason, there was a problem that the apparatus warns many times unless an user instructs a proper Nin1 printing.

### SUMMARY

An aspect of the present disclosure relates to an image processing apparatus, containing: a receiving portion to receive an image data composed of a plurality of pages and a print data including an information indicating a size of characters included in the image data; a decision portion, in case of generating an Nin1 image so as to reduce and print in a page images of different N (N is a positive integer) pages out of the plurality of pages of the print data received in the receiving portion, to decide a value of N within a range where the size of the characters of the Nin1 image is more than a prescribed value based on the information indicating the size of the characters; and a generating portion to generate the Nin1 image according to the value of N decided in the decision portion.

Another aspect of the present disclosure relates to an image processing method containing: receiving an image data composed of a plurality of pages and a print data including an information indicating a size of characters included in the image data; deciding a value of N for the print data, in case of generating an Nin1 image so as to reduce and print in a page the image of the different N pages out of the plurality of pages of the print data, within a range where the size of the characters of the Nin1 image is more than a prescribed value based on the information indicating the size of the characters; and generating the Nin1 image according to the decided value of N.

Further an aspect of the present disclosure relates to an image processing apparatus, containing: an interface to receive an image data composed of a plurality of pages and a print data including an information indicating a size of characters included in the image data; a memory to store a minimum size of the characters in case of printing the image data of the N (N is a positive integer) pages in a page in a lump; a processor to detect the minimum size of the characters in the print data received in the interface, to decide a value of N so as to reduce and print in a page based on the minimum size of the characters stored in the memory and the detected minimum size of the characters, and to generate the Nin1 image according to the value of N decided so as to print the image of the N pages in a page.

### DESCRIPTION OF THE DRAWINGS

FIG. 1 is a block diagram of a processing portion of an Nin1 printing in a first embodiment;

FIG. 2 is a correspondence table between a character size and an Nin1 print setting;

FIG. 3 is a flow chart in the first embodiment;

FIG. 4 is a display example of a warning screen in the first embodiment;

FIG. 5 is a block diagram of a processing portion of an Nin1 printing in a second embodiment;

FIG. 6 is a flow chart in the second embodiment;

FIG. 7 is a display example of a warning screen in the second embodiment;

FIG. 8 is a block diagram of a processing portion of an Nin1 printing in a third embodiment;

FIG. 9 is a display example of an option setting screen for the automatic Nin1 setting;

FIG. 10 is a flow chart in the third embodiment; and

FIG. 11 is a flow chart in the third embodiment.

### DETAILED DESCRIPTION

Hereinafter, embodiments of the present invention will be described with reference to the drawings.

### First Embodiment

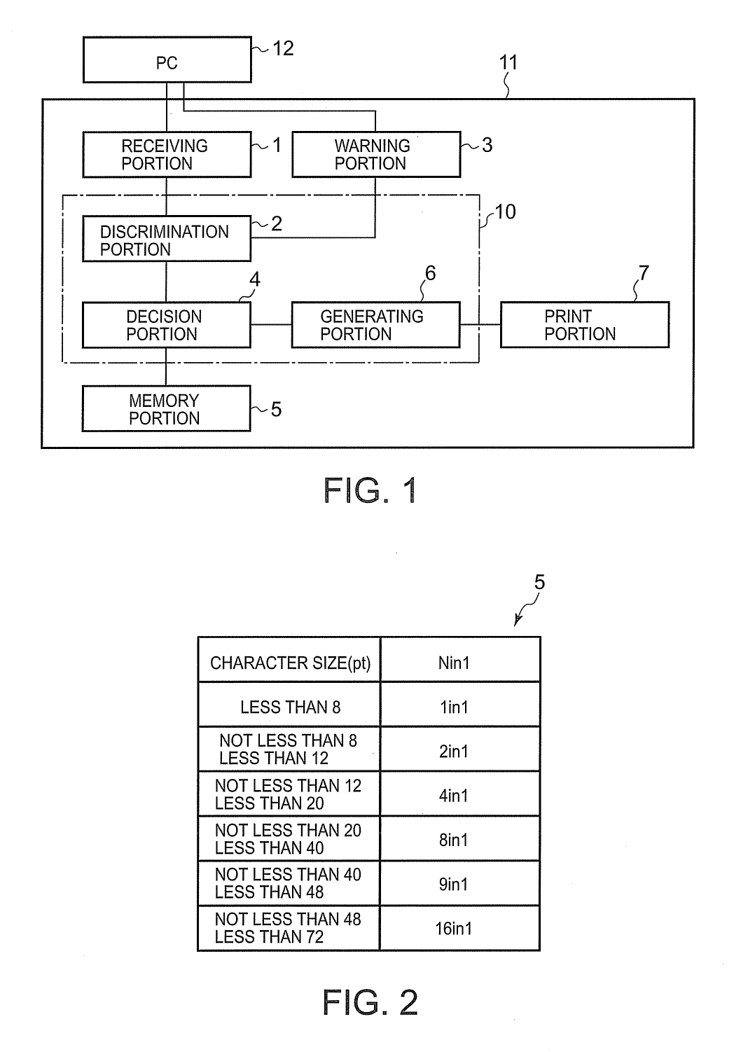

### A first embodiment will be described with reference to FIG. 1 through FIG. 4. In the present embodiment, an image processing apparatus is an image forming apparatus.

Hereinafter, a printing method to reduce N (N is a positive integer) pages with different print data into one page and to print the one page is called as an Nin1 printing. That a value of N is automatically decided without setting the value of N by a user and an Nin1 printing is set is called as an automatic Nin1 setting.

FIG. 1 is a block diagram showing a processing portion relating to print processing in the present embodiment. An image forming apparatus 11 is connected to a PC (personal Computer) which is an external apparatus. The PC 12 is provided with a printer driver to control the connected image forming apparatus 11.

The image forming apparatus includes an interface 1, a discrimination portion 2, a warning portion 3, a memory portion 5, a generating portion 6 and a print portion 7. The interface 1 functions as a receiving portion to receive image data and in addition print data provided with an information showing a size of the characters included in the image data by a print request from the printer driver of the PC 12. The discrimination portion 2 discriminates whether or not the automatic Nin1 setting is made. The warning portion warns the user in case that the automatic Nin1 setting is not made. The memory portion 5 stores a correspondence relationship between a size of the characters included in the print data and a value of N which is a maximum natural number in a range where a size of characters in an Nin1 image is more than a prescribed value. The decision portion 4 reads out a value of N from the memory portion 5 based on the information showing a size of the characters included in the print data, and decides the value of N. The generating portion 6 generates an Nin1 image based on the value of N decided by the decision portion 4. The print portion 7 prints the Nin1 image generated by the generating portion 6. The prescribed value is a value of a marginal size of the characters which the ordinary person feels not easy to read. The discrimination portion 2, the decision portion 4 and the generating portion 6 are included in a processor 10. In addition, the print portion 7 includes a printer part.

FIG. 2 is a drawing showing an internal construction of the memory portion 5. The memory portion 5 stores a value of N corresponding to a size of the characters included in print data. The larger a size of the characters included in print data, the larger a value of N becomes.

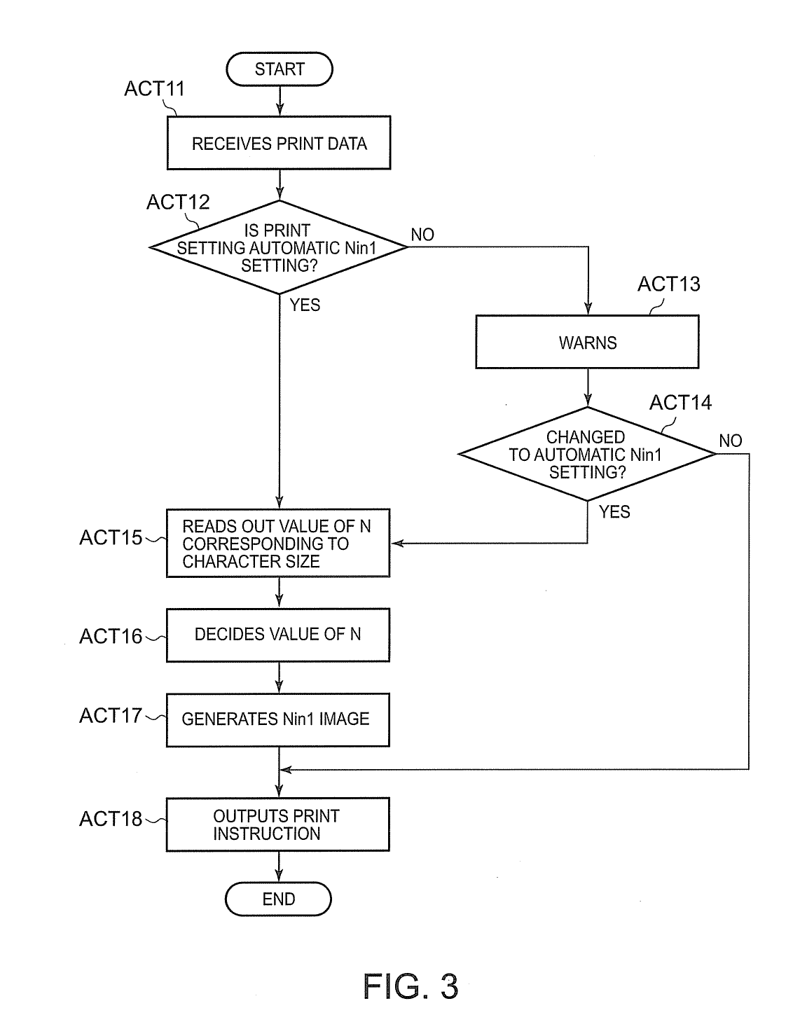

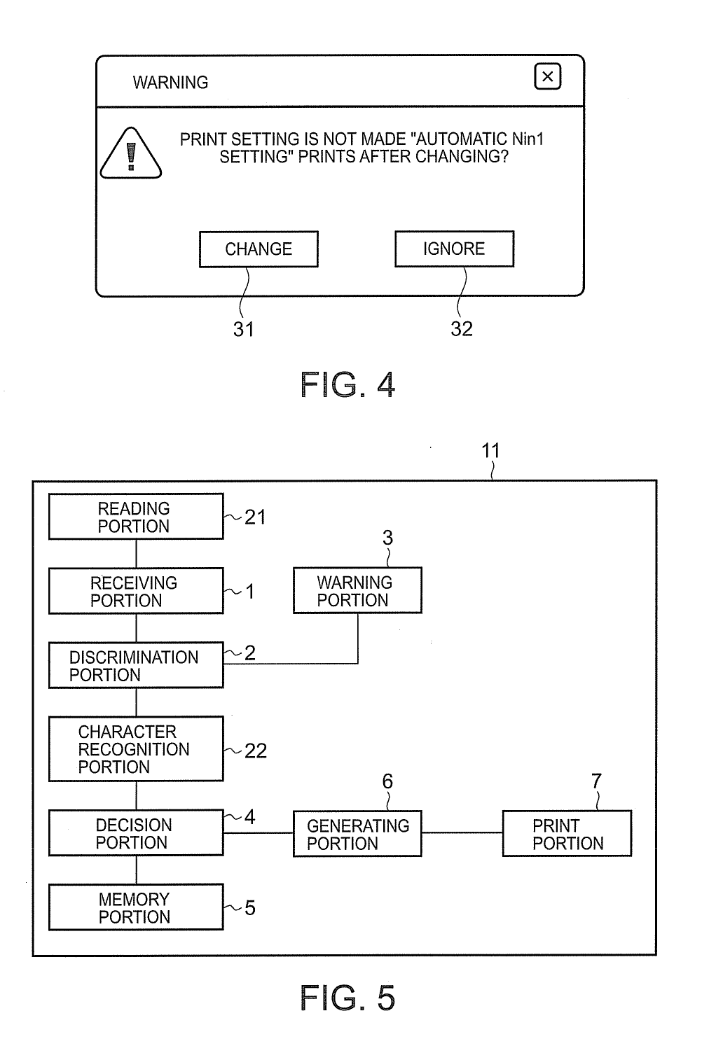

FIG. 3 is a flow chart in case that a print processing is performed. To begin with, if a print request is given from the PC 12 by a user, the interface 1 receives the print data (ACT11). Next, the discrimination portion 2 discriminates whether or not the print setting is an automatic Nin1 setting (ACT12). In case that the automatic Nin1 setting is not made (NO in ACT12), the warning portion warns the user (ACT13), and urges to change to the automatic Nin1 setting. This is done by displaying a warning image as shown in FIG. 4 on a screen of the PC 12 or on an operating panel of the image forming apparatus 11. A “CHANGE” button 31 in the screen is pushed down, the setting is changed to the automatic Nin1 setting (YES in ACT14). An “IGNORE” button 32 is pushed down, the printing is done without changing to the automatic Nin1 setting (NO in ACT14).

In case that the automatic Nin1 setting is made (YES in ACT12), or in case that the setting is changed to the automatic Nin1 setting in ACT14 (YES in ACT14), the decision portion 4 reads out the value of N corresponding to the size of the characters from the memory portion 5 based on the information of the size of the characters included in the print data (ACT15). Then, the decision portion 4 decides the value of N used in the Nin1 printing from the value of N which is read out (ACT16).

In addition, the character size used in deciding the corresponding value of N is a minimum character size in the whole characters included in the print data. By using the minimum character size, to appear the unreadable characters can be prevented in case of the Nin1 printing. When the value of N is decided by the decision portion 4 in ACT17, the generating portion 6 generates the Nin1 image using the value of N decided by the decision portion 4. Then an instruction is outputted to print the generated Nin1 image by the print portion 8 (ACT18). In addition, in case that ACT14 is NO, the processing in ACT18 is performed.

In addition, in the above-described, only the information indicating the character size is attached to the print data. But, by adding the information indicating the kind of the characters to the print data, the correspondence table shown in FIG. 2 between the character size and the value of N for the kinds of the characters may be stored in the memory portion 5. If the kinds of the characters are different, that the correspondences between the character size and the value of N may be different is considered. For example, usually, in case that the smaller the character size becomes, the more unreadable the characters are, in “Mincho” typeface than in Gothic typeface. So that, to change the optimum value of N correspondingly to the character size is preferable for a user. For the reason, if the corresponding table between the character size and the value of N as shown in FIG. 2 is stored for the kinds of the characters, a more suitable Nin1 image can be printed.

In addition, in the present embodiment, the character sizes of whole the characters included in the image data are targeted in case of deciding the value of N. But, the value of N may be decided in consideration of only the sizes of the characters included in a prescribed area. For, example, usually, the page numbers are indicated in a header or a footer in many cases. But some users do not mind if the page numbers can not be read. For the reason, if the user can designate so that the value of N is decided in consideration of only the characters included in the area except the header and footer, the characters indicating the page numbers shown in the header and footer can be ignored in deciding the value of N.

In addition, the designation of the character which is used to decide the value of N can be made for each user, for example, the characters which are included in the characters by a prescribed ratio are targeted in deciding the value of N.

By employing the above-described embodiment, the proper Nin1 setting is performed automatically from the character information of the print data, so that a user will not be required to designate the Nin1 setting.

In addition, in the above-described embodiment, a reduced print processing apparatus is described taking an image forming apparatus for example. But without being limited to the embodiment, the PC may be embodied as a reduced print processing apparatus.

### Second Embodiment

A second embodiment will be described with reference to FIG. 5 through FIG. 7. Hereinafter, the same reference numerals are used for the same parts in the above-described embodiment, and only the characteristic parts of the present embodiment will be described.

In the present embodiment, an Nin1 setting will be described in case that copying is performed in the image forming apparatus 11.

FIG. 5 is a block diagram showing a processing portion relating to the print processing in the present embodiment. In addition to the construction of the first embodiment, the image forming apparatus 11 is provided with a reading portion 21 to read out a document to be copied, a character recognition portion 22 to recognize the characters and the character sizes in the read out image data.

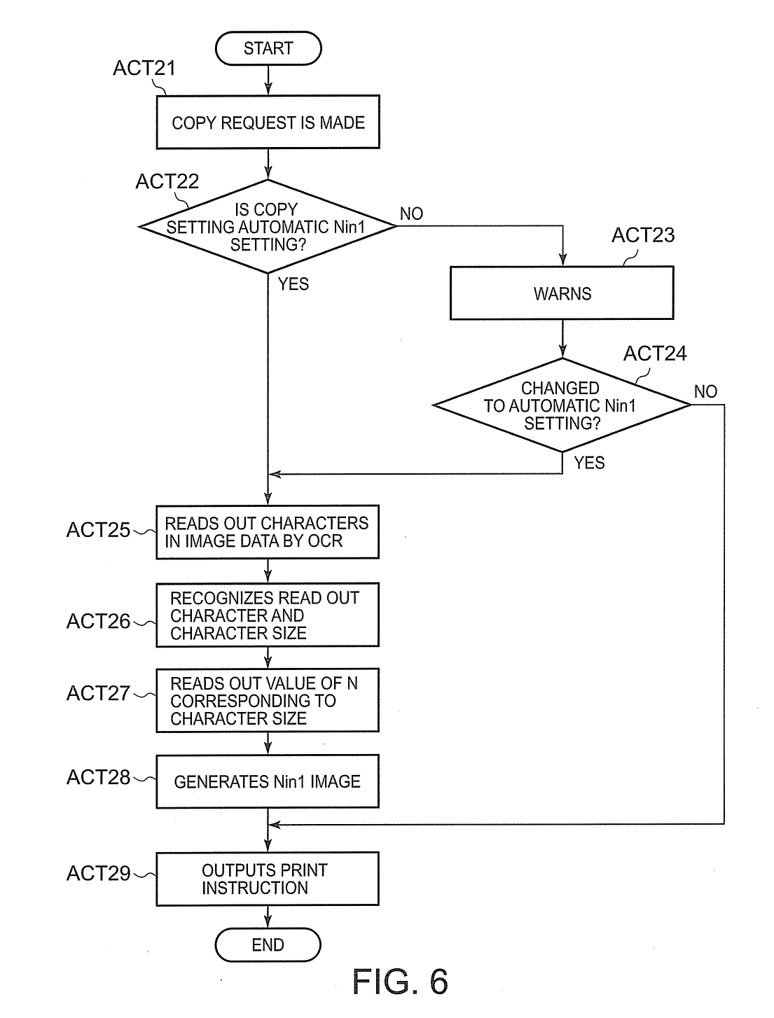

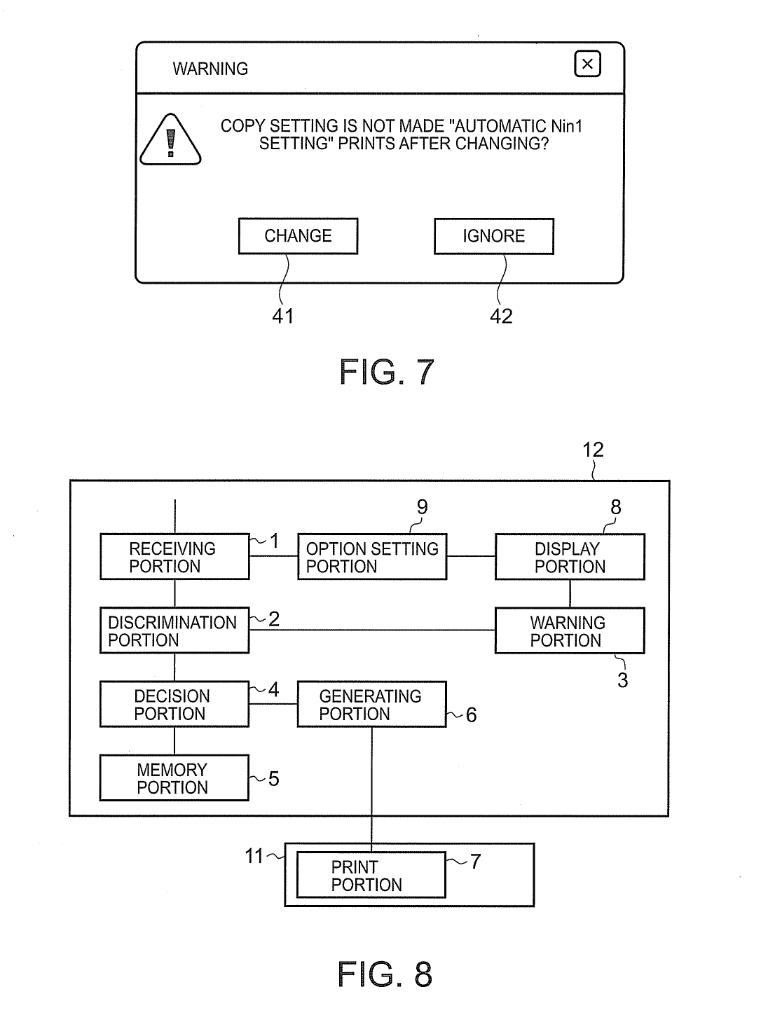

FIG. 6 is a flow chart showing print processing in the present embodiment. First, the document is read out by the reading portion 21, and based on a copy request from a user, the reading portion 21 reads out the document, and in addition, performs the following processing taking an image of the document read out in the interface 1 as the print data (ACT21). Then, the discrimination portion 2 discriminates whether or not the copy setting is made as an automatic Nin1 setting (ACT22). In case that the copy setting is not made as the automatic Nin1 setting is discriminated (NO in ACT22), the warning portion 4 warns the user (ACT23). The warning is performed by displaying a warning screen as shown in FIG. 7 on an operating panel (not shown) of the image forming apparatus 11. Then, the discrimination portion 2 discriminates whether or not the setting is changed to the automatic Nin1 setting (ACT24).

In case that the warning screen as shown in FIG. 7 is outputted, if that a “CHANGE” button 41 on the screen shown in FIG. 7 has been pushed down is discriminated (YES in ACT24), the setting is changed to the automatic Nin1 setting. In case that an “IGNORE” button 41 has been pushed down is detected (NO in ACT24), the setting is not changed to the automatic Nin1 setting.

In case that the automatic Nin1 setting is made (YES in ACT22 and YES in ACT24), the character recognition portion 22 performs an OCR (Optical Character Recognition) processing (ACT25). The character recognition portion 22 recognizes the characters in the print data read out by the reading portion 21, and obtains the information of the character size (ACT26).

The decision portion 4, reads out a value of corresponding N from the correspondence table stored in the memory portion 5 based on the character size obtained in ACT26, and decides the value of N (ACT27).

The generating portion 6 generates an Nin1 image following to the value of N decided by the decision portion 4 (ACT28). Then, to print the generated Nin1 image by the print portion 7 is indicated (ACT29).

By employing the above-described embodiment, in case of copying, the user is not required to make the Nin1 setting repeatedly, and can perform an optimum Nin1 printing.

In addition, by performing the OCR processing for the image data, in consideration of the size of the characters included in the illustration and so on in the image data, an optimum value of N can be decided.

### Third Embodiment

A third embodiment will be described with reference to FIG. 8 through FIG. 10. Hereinafter, the same reference numerals are used for the same parts in the above-described embodiments, and only the characteristic parts of the present embodiment will be described. The present embodiment is a case where an Nin1 print processing apparatus is a PC. That is, in the present embodiment, an automatic Nin1 print setting is made by the PC 12 provided with a printer driver. In addition, in the present embodiment, an user can set an option for the automatic Nin1 setting.

FIG. 8 is a block diagram showing a processing portion of the PC 12 and the image forming apparatus 11 connected to the PC 12.

The PC 12 has the interface 1 to receive the print data and the option for the automatic Nin1 print setting, the discrimination portion 2 to discriminate whether or not the automatic Nin1 setting is made, the warning portion 3 to warn the user in case that the automatic Nin1 setting is not made, the memory portion 5 to memory the correspondence relationship between the size of the characters included in the print data and the value of N which is the maximum natural number in the range where the size of the characters in the Nin1 image is more than the prescribed number, the decision portion 4 to read out the value of N from the memory portion 5 based on the information indicating the size of the characters included in the print data and to decide the value of N, and the generating portion 6 to generate the Nin1 image based on the value of N decided by the decision portion 4.

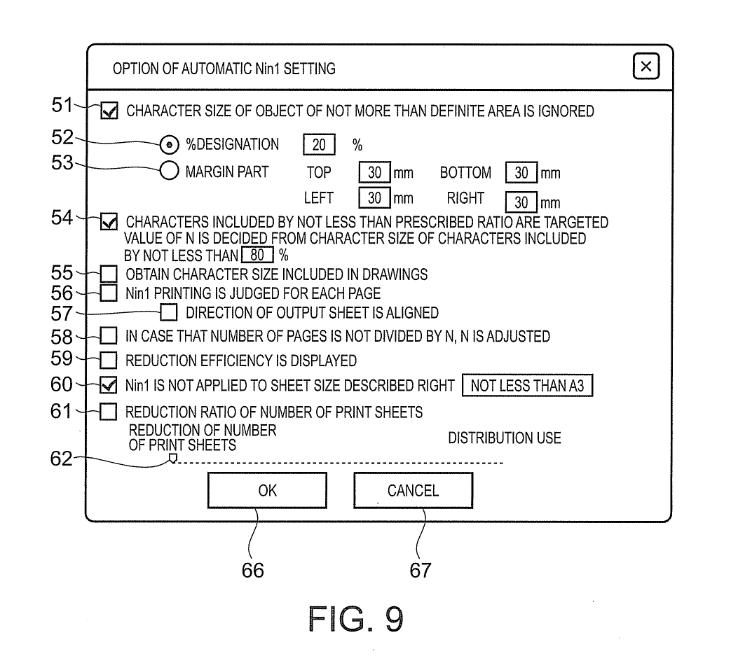

In addition, the PC 12 has a display portion 8 to display the information which is warned out from the warning portion 3 and to display an option screen from which the user can select the Nin1 setting, and an option setting portion 9 to set the option selected by the display portion 8. An example of the option screen is shown in FIG. 9.

The Nin1 image generated in the generating portion 6 is sent to the image forming apparatus 11, and is printed by the print portion 7 of the image forming apparatus 11. In addition, the interface 1 receives the information selected by the user on the option screen displayed on the display portion 8.

Next, the setting items on the option screen will be described. As one of the option items, an item 51 named “CHARACTER SIZE OF OBJECT OF NOT MORE THAN DEFINITE AREA IS IGNORED” is provided. In the item 51, an item “% DESIGNATION” 52 and an item “MARGIN PART” 53 are further provided. When an check is inputted in the item “CHARACTER SIZE OF OBJECT OF NOT MORE THAN DEFINITE AREA IS IGNORED” 51, the item “% DESIGNATION” 52 and the item “MARGIN PART” 53 can be selected.

The item “% DESIGNATION” 52 is an item to instruct so as to ignore the size of the characters in the object, such as a table or a textbox, which is less than a prescribed ratio in a page of a document. For, example, in FIG. 9, “20%” is designated. In this case, that the character size in the object less than 20% in one page as a whole is ignored can be instructed.

An item “MARGIN PART” 53 can instruct so as to ignore the size of characters written in the margin part, by designating the margin. The margin part can designate the sizes of margins at TOP, BOTTOM, LEFT and RIGHT sides.

By selecting the options by a user as described above, only the size of the characters in the prescribed area as shown in the first embodiment can be targeted in case of deciding the value of N.

An item “CHARACTERS INCLUDED BY NOT MORE THAN PRESCRIBED RATIO ARE TARGETED” 54 is an item in which an user can designate a threshold value of the ratio of the characters to be targeted which are included in whole the document. In FIG. 9, “80%” is indicated, the item can decide an optimum value of N from the size of the characters included in whole the document by not less than 80%. In case that the designation is not made, if only one character indicating the minimum size of characters is included, the value N is decided correspondingly to the character. By requiring the item 54 named “CHARACTERS INCLUDED BY NOT MORE THAN PRESCRIBED RATIO IS TARGETED”, the characters included in the document in only small amount can be excluded from the target in case of obtaining the value of N.

An item “OBTAIN CHARACTER SIZE INCLUDED IN DRAWING” 55 is an item which can instruct so that the size of the characters included in the drawing, such as an illustration and so on, included in the print data is targeted. By the item, the characters included in the drawing can be used in case of deciding a proper value of N.

An item “Nin1 PRINTING IS JUDGED FOR EACH PAGE” 56 is an item which, in case that the document is composed of a plurality of pages, does not make an optimum Nin1 print setting from the size of the characters in whole the document, but instructs so that the optimum value of N in each page is decided by judging the character size in each page of the document.

Based on the balance of the value of N in the surrounding pages, the Nin1 image is generated so as to make the blank part small in the sheet after printing and to make the number of prints minimum. If the item is selected, in case that 2 in1 is optimum for a first page of the document is discriminated and that 8in1 is optimum for second through ninth pages is discriminated, the first page of the document is outputted in 1in1 and the second through ninth pages are outputted in 8in1.

In the above-described example, in case that the value of N is decided based on whole the document, the value of N becomes two and the document is printed in 2in1. As a result, the number of prints becomes five sheets. On the other hand, in case that the value of N is decided for each page, the number of prints becomes two sheets. And compared with the case that the value of N is decided for whole the document, the number of prints can be reduced.

In addition, not by printing using the value of N discriminated in each page without modification, but in consideration of the balance for the surrounding pages, the blank parts can be made smaller after printing. If explained for the above-described example, 2 in1 is discriminated to be optimum for a first page of the document. Accordingly, if the first page is printed in 2in1 without modification and the second through ninth pages are outputted in 8in1, on a first outputted sheet, only a first page of the document is printed in 2in1 state. That is, a half of the sheet becomes blank part, and accordingly an ineffective part is generated. For the reason, by printing the first page of the document in 1in1 which is different from the result of the value of N discriminated for the page, the blank ineffective area can be eliminated.

In addition, if the item “Nin1 PRINTING IS JUDGED FOR EACH PAGE” 56 is selected, an item “DIRECTION OF OUTPUT SHEET IS ALIGNED” 57 can be selected. The item “DIRECTION OF OUTPUT SHEET IS ALIGNED” 57 is an item to instruct so that the directions of the sheets are aligned in case of printing out. If a plurality of Nin1 print settings are mixed in case of outputting a document, the directions of the outputted sheets may be different by the Nin1 print settings.

For example, in case that a 2in1 print setting and a 4in1 print setting are mixed, for a usual document in the length direction, the output sheet in 2in1 becomes in the width direction and the output sheet in 4 in1 becomes in the length direction. As a result, the outputted sheets are mixed in the length direction and the width direction. If the directions of the outputted sheets are different as described above, the outputted sheets may possibly be difficult to read. For the reason, in such a case, if the item “DIRECTION OF OUTPUT SHEET IS ALIGNED” 57 is selected, the Nin1 setting is made to the 2in1 setting in the above-described example, and accordingly the outputted sheets are all unified in the width direction.

An item “IN CASE THAT NUMBER OF PAGES IS NOT DIVIDED BY N, N IS ADJUSTED” 58 is an item to instruct so that the blank part of the sheet in case of printing out is made small. In the item, the following setting can be made. For example, in case that the document is composed of only one page, no matter how many N discriminated by the character size of the document is, the document is printed out in 1in1. And in case that the document composed of pages of an odd number is outputted in 2 in1, only the last page is outputted in 1in1. That is, not by following just the Nin1 print setting judged by the character size, but the blank part in the sheet when outputted can be adjusted to be small.

An item “REDUCTION EFFICIENCY IS DISPLAYED” 59 is an item which can display how many pages of the sheets can be reduced and so on compared with a usual case that a page of the document is printed on a sheet (1 in1). By displaying the number of sheets which can be reduced, the awareness to the ecology for a user can be enhanced.

An item “Nin1 PRINTING IS NOT APPLIED TO SHEET SIZE DESCRIBED RIGHT” 60 is an item to instruct so that the Nin1 printing is not performed in case of printing in the designated sheet size. By selecting the item, the size of the sheets in which an user do not want to perform the Nin1 printing can be preliminarily excluded.

In addition, if an item “REDUCTION RATIO OF NUMBER OF PRINT SHEETS” 61 is selected, a degree can be selected by a slider system 62 within a range from “REDUCTION OF NUMBER OF PRINTS SHEETS” to “DISTRIBUTION USE”. If a user slides in the direction for “REDUCTION OF NUMBER OF PRINTS SHEETS”, the options in the items 51-60 are selected so that the number of print sheets is reduced after image forming. If a user slides in the direction for “DISTRIBUTION USE”, the options in the items 51-60 are selected so that the printed sheets are more visible for the user, though the number of the print sheets after image forming is more compared with the case of “REDUCTION OF NUMBER OF PRINT SHEETS”. If the slider system is employed in selecting the options in the automatic Nin1 setting as described above, the use is not required to make precise setting, and the load for the used can be reduced.

In addition, an OK button 66 to determine the item to be selected and a CANCEL button 67 to cancel the item are provided on the option screen.

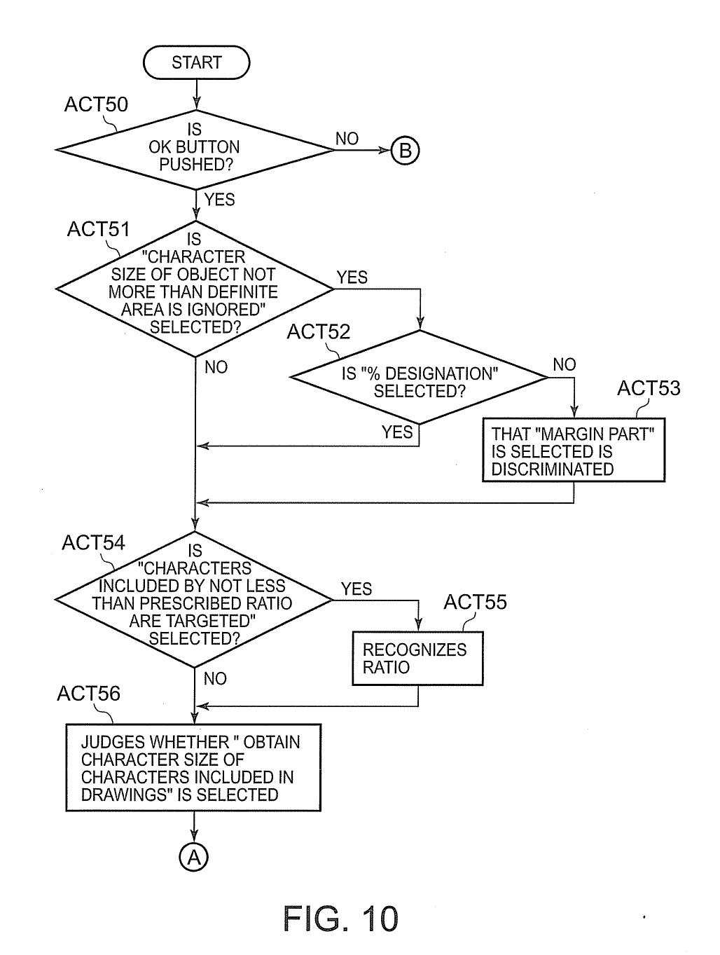

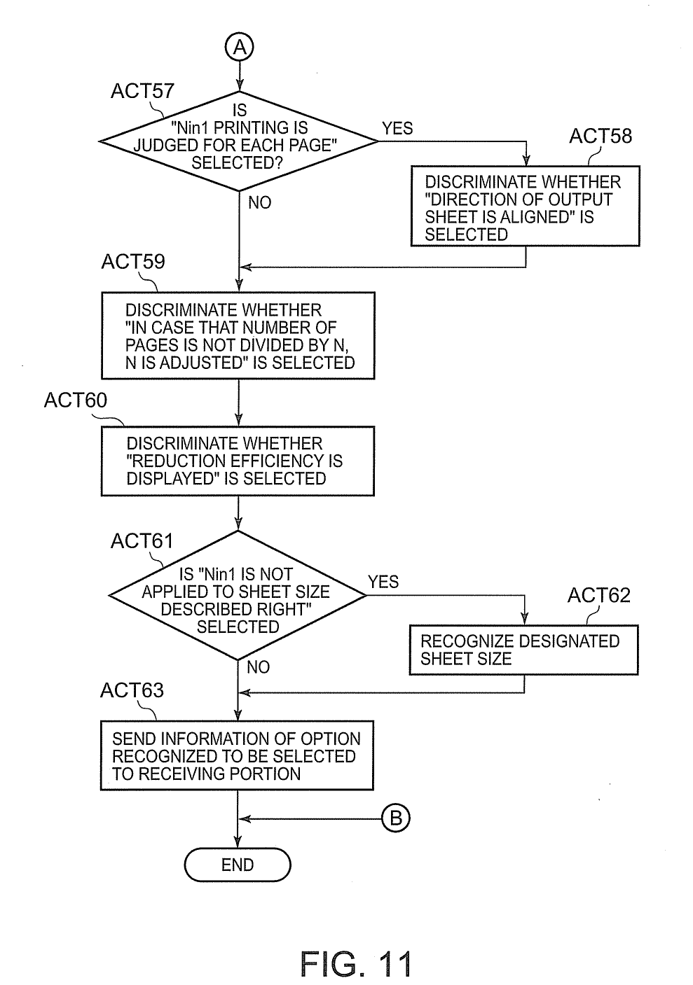

Next, the processing in the option setting portion 9 to send the selected option information along with the print data to the interface 1 will be described with reference to flow charts shown in FIG. 10 and FIG. 11.

The option setting portion 9 discriminates whether or not the OK button 66 is pushed down on the option selection screen for the automatic Nin1 setting shown in FIG. 9 (ACT50). If the option setting portion 9 can not detect that the OK button is pushed down (NO in ACT50), discriminates that the CANCEL button 67 is pushed down, and stops the processing.

If the option setting portion 9 can detect that the OK button is pushed down (YES in ACT50), detects which items are selected.

At first, whether or not the item “CHARACTER SIZE OF OBJECT OF NOT MORE THAN DEFINITE AREA IS IGNORED” 51 is selected is discriminated (ACT51). If the option setting portion 9 discriminates that the item “CHARACTER SIZE OF OBJECT OF NOT MORE THAN DEFINITE AREA IS IGNORED” 51 is selected (YES in ACT51), discriminates whether or not the item “% DESIGNATION” 52 is selected (ACT52). If the option setting portion 9 discriminates that the item “% DESIGNATION” 52 is not selected (NO in ACT52), discriminates that the other item “MARGIN PART” 53 is selected (ACT53).

After the option setting portion 9 discriminates that the item “CHARACTER SIZE OF OBJECT OF NOT MORE THAN DEFINITE AREA IS IGNORED” 51 is not selected (NO in ACT51), or after discriminates that the item “% DESIGNATION” 52 is selected (YES in ACT52), or after discriminates that the item “MARGIN PART” is selected (ACT53), discriminates whether or not the item “CHARACTERS INCLUDED BY NOT LESS THAN PRESCRIBED RATIO ARE TARGETED” 54 is selected (ACT54). If the option setting portion 9 discriminates that the item “CHARACTERS INCLUDED BY NOT LESS THAN PRESCRIBED RATIO ARE TARGETED” 54 is selected (YES in ACT54), recognizes the ratio designated by the item 54 (ACT55).

After the option setting portion 9 discriminates that the item “CHARACTERS INCLUDED BY NOT LESS THAN PRESCRIBED RATIO ARE TARGETED” 54 is not selected (NO in ACT54), or after recognizes the ratio designated by the item 54 (ACT55), discriminates whether or not the “OBTAIN CHARACTER SIZE INCLUDED IN DRAWINGS” 55 is selected (ACT56).

After the option setting portion 9 discriminates whether or not the item “OBTAIN CHARACTER SIZE INCLUDED IN DRAWINGS” 55 is selected (ACT56), discriminates whether or not the item “Nin1 PRINTING IS JUDGED FOR EACH SHEET” 56 is selected (ACT57). If the option setting portion 9 discriminates that the item “Nin1 PRINTING IS JUDGED FOR EACH SHEET” 56 is selected (YES in ACT57), discriminates whether or not the item “DIRECTION OF OUTPUT SHEET IS ALIGNED” 57 is also selected (ACT58).

After the option setting portion 9 discriminates that the item “Nin1 PRINTING IS JUDGED FOR EACH SHEET” 56 is selected and discriminates whether or not the item “DIRECTION OF OUTPUT SHEET IS ALIGNED” 57 is selected (ACT58), or after discriminates that the item “Nin1 PRINTING IS JUDGED FOR EACH SHEET” 56 is not selected (NO in ACT57), discriminates whether or not the item “IN CASE THAT NUMBER OF PAGES IS NOT DIVIDED BY N, N IS ADJUSTED” 58 is selected (ACT59).

After the option setting portion 9 discriminates whether or not the item “IN CASE THAT NUMBER OF PAGES IS NOT DIVIDED BY N, N IS ADJUSTED” 58 is selected (ACT59), discriminates whether or not the item “REDUCTION EFFICIENCY IS DISPLAYED” 59 is selected (ACT60).

After the option setting portion 9 discriminates whether or not the item “REDUCTION EFFICIENCY IS DISPLAYED” 59 is selected (ACT60), discriminates whether or not the item “Nin1 IS NOT APPLIED TO SHEET SIZE DESCRIBED RIGHT” 60 is selected (ACT61). If the option setting portion 9 discriminates that the item “Nin1 IS NOT APPLIED TO SHEET SIZE DESCRIBED RIGHT” 60 is selected (YES in ACT61), recognizes the designated sheet size (ACT62).

After the option setting portion 9 discriminates that the item “Nin1 IS NOT APPLIED TO SHEET SIZE DESCRIBED RIGHT” 60 is not selected (NO in ACT61), or after recognizes the designated sheet size (ACT62), sends the option information which is discriminated to be selected (ACT63), and stops the processing.

As described above, by making so that the option of the automatic Nin1 setting can be made by a user, the user can select automatically the Nin1 printing which the user desires. In addition, several kinds of the option settings made by the user as described above may be stored. By storing the option settings, the user is not required to set the option every time, but the user only reads out the stored setting, so that the load for the use can be reduced.

In addition, the third embodiment is performed on the PC 12. But without limited to this case, the embodiment may be performed in the image forming apparatus 11.

In the disclosed embodiments, the processing can be accomplished by a computer-executable program, and this program can be realized in a computer-readable memory device. In the embodiments, the memory device, such as a magnetic disk, a flexible disk, a hard disk, an optical disk (CD-ROM, CD-R, DVD, and so on), an optical magnetic disk (MD and so on) can be used to store instructions for causing a processor or a computer to perform the processes described above.

What is claimed is:

1. An image processing apparatus, comprising:
a receiving portion to receive an image data composed of a plurality of pages and a print data including an information indicating a size of characters included in the image data;
a decision portion, in case of generating an Mini image so as to reduce and print in a page images of different N (N is a positive integer) pages out of the plurality of pages of the print data received in the receiving portion, to decide a value of N within a range where the size of the characters of the Mini image is more than a prescribed value based on the information indicating the size of the characters; and
a generating portion to generate the Mini image according to the value of N decided in the decision portion.

2. The apparatus of claim 1, further comprising:
a memory portion to store the size of the characters included in the print data and the value of N corresponding to the size of the characters;
wherein the decision portion reads out the value of N corresponding to the size of the characters included in the print data from the memory portion.

3. The apparatus of claim 1, wherein the decision portion decides the value of a natural number N within a range where the size of the characters of the Nin1 image is more than the prescribed value.

4. The apparatus of claim 2, wherein the values of N stored in the memory portion are different for kinds of the characters, the receiving portion also receives an information of the kind of the characters, and the decision portion decides the value of N coupled with the kind of the characters.

5. The apparatus of claim 1, wherein the decision portion decides the value of N based on an information indicating a size of the characters included in an area of the print data designated by a user.

6. The apparatus of claim 1, wherein the decision portion targets the image of each page out of the plurality of pages received by the receiving portion so as to calculate the value of N, and the generating portion generates the value of N based on the image of each targeted page out of the plurality of pages.

7. The apparatus of claim 1, further comprising:
a print portion to print the Nin1 image generated by the generating portion.

8. The apparatus of claim 7, further comprising:
a reading portion to read out the image of a document; and
a character recognition portion to recognize the characters included in the image data read out by the reading portion and the information of the size of the characters,
wherein the decision portion decides the value of N based on the size of the characters recognized by the character recognition portion in case of performing the Nin1 printing.

9. An image processing method, comprising:
receiving an image data composed of a plurality of pages and a print data including an information indicating a size of characters included in the image data;
deciding a value of N for the print data, in case of generating an Nin1 image so as to reduce and print in a page the image of the different N pages out of the plurality of pages of the print data, within a range where the size of the characters of the Nin1 image is more than a prescribed value based on the information indicating the size of the characters; and
generating the Nin1 image according to the decided value of N.

10. The method of claim 9, further comprising:
storing the size of the characters included in the print data and the value of N corresponding to the size of the characters in a memory portion;
wherein the deciding reads out the value of N corresponding to the size of the characters included in the print data from the memory portion.

11. The method of claim 9, wherein:
the deciding decides the value of a natural number N within a range where the size of the characters of the Nin1 image is more than the prescribed value.

12. The method of claim 10, wherein the values of N stored in the memory portion are different for kinds of the characters, the receiving also receives an information of the kind of the characters, and the deciding decides the value of N coupled with the kind of the characters.

13. The method of claim 9, wherein:
the deciding decides the value of N based on an information indicating a size of the characters included in an area of the print data designated by a user.

14. The method of claim 9, wherein the deciding targets the image of each page out of the plurality of pages received by the receiving so as to calculate the value of N, and the generating generates the value of N based on the image of each targeted page out of the plurality of pages.

15. The method of claim 9, further comprising:
printing the Nin1 image generated by the generating.

16. The apparatus of claim 15, further comprising:
reading out the image of a document; and
recognizing the characters included in the read out image data and the information of the size of the characters;
wherein the deciding decides the value of N based on the size of the characters recognized.

17. An image processing apparatus, comprising:
an interface to receive an image data composed of a plurality of pages and a print data including an information indicating a size of characters included in the image data;
a memory to store a minimum size of the characters in case of printing the image data of the N (N is a positive integer) pages in a page in a lump;
a processor to detect the minimum size of the characters in the print data received in the interface, to decide a value of N so as to reduce and print in a page based on the minimum size of the characters stored in the memory and the detected minimum size of the characters, and to generate the Nin1 image according to the value of N decided so as to print the image of the N pages in a page.

18. The apparatus of claim 17, wherein the minimum size of the characters stored in the memory are different for the kinds of the characters, the interface also receives an information of the kind of the characters, and the processor decides the value of N coupled with the kind of the characters.

19. The apparatus of claim 17, wherein the processor decides the value of N based on an information indicating the minimum size of the characters included in an area of the print data designated by a user.

20. The apparatus of claim 17, further comprising:
a printer to print the Nin1 image generated by the processor.
